(19) United States
(12) Patent Application Publication
(10) Pub. No.: US 2020/0311915 A1
(43) Pub. Date: Oct. 1, 2020

(54) GROWTH STATUS PREDICTION SYSTEM AND METHOD AND COMPUTER-READABLE PROGRAM

(71) Applicant: OPTIM CORPORATION, Saga (JP)

(72) Inventor: Shunji SUGAYA, Tokyo (JP)

(21) Appl. No.: 16/768,127

(22) PCT Filed: Nov. 29, 2017
(86) PCT No.: PCT/JP2017/042696

§ 371 Date: May 29, 2020

(51) Int. Cl. G06T 7/00; G06N 20/00

(52) U.S. Cl. CPC G06T 7/0012; G16Y 10/05; G06N 20/00

(57) ABSTRACT

Provided is a system for predicting a future growth status and diseases and pests in a field through image analysis. The system includes an image acquisition unit configured to acquire a captured image of the field; a detection unit configured to analyze the image to detect the growth status of an object; an environment information acquisition unit configured to acquire current environment information of the field; a past environment information acquisition unit configured to acquire past environment information which is past environment information of an object in the field; and a prediction unit configured to predict a future growth status based on the detected growth status, the current environment information and the past environment information.

### CROSS-REFERENCES TO RELATED APPLICATION

This application is a national phase under 35 U.S.C. § 371 of International Application No. PCT/JP2017/042696 filed Nov. 29, 2017, which is hereby incorporated by reference in its entirety.

### TECHNICAL FIELD

The present disclosure relates to a system and method for predicting a growth status or a disease and pest occurrence status, and a program.

### BACKGROUND

In recent years, progress has been made in predicting a growth status and a disease and pest occurrence status of crops.

For example, a system for predicting a growth status of a crop is provided to suppress deviation of crop quality and yield (Patent Document 1). In addition, a system for grasping information about diseases and pests in detail is provided (Patent Document 2).

That is, in Patent Document 1, a field management method is proposed, which acquires information about climate, temperature, wind, frost, pests, soil composition, crop quantity, and sunshine amount, and predicts the growth status based on the information, which is applied to field management. Therefore, there is no deviation since the intuition and experience of the grower is not relied on.

In addition, Patent Document 2 proposes a system in which an occurrence forecast of diseases and pests related to a crop consistent with a crop cultivated by an agricultural operator is displayed together with an image of an area where the crop is cultivated. Therefore, information relevant to only the cultivated crop is grasped in detail.

### DOCUMENTS IN THE EXISTING ART

### Patent Documents

Patent Document 1: Japanese Laid Open Patent Publication No. 2016-49102.
Patent Document 2: Japanese Laid Open Patent Publication No. 2016-167214.

### SUMMARY

### Problem to be Solved in the Invention

However, in systems described in Patent Document 1 and Patent Document 2, it is impossible to detect a current growth status and a disease and pest occurrence status in combination with image analysis of crops and apply these statuses to prediction.

That is, for knowing an actual status of the crops, shooting the field is the most direct way. In order to predict future growth, it is necessary to grasp the present status as accurately as possible.

In addition, for knowing disease and pest occurrence status of the crops, shooting the field is also the most direct way to grasp the disease and pest occurrence status and extent. To predict a future disease and pest damage, it is necessary to grasp a current damage status as accurately as possible.

The present invention has been made in view of such problems, and its purpose is to obtain a system, method, and program for predicting a growth status and a disease and pest occurrence status of the field in the future through the image analysis.

### Solution to the Problem

Inventors of the present invention have conducted extensive studies to achieve the above-mentioned subjects, and have found that the problems may be solved by using analysis results of the image captured in the field in addition to current environment information and past environment information, thus completing the present invention. Specifically, in the present invention, the following solutions are provided.

(1) The present invention provides a growth status prediction system that predicts a growth status in a field, and the system includes an image acquisition unit configured to acquire a captured image of the field; a detection unit configured to analyze the image to detect the growth status of an object; an environment information acquisition unit configured to acquire current environment information of the field; a past environment information acquisition unit configured to acquire past environment information which is past environment information of an object in the field; and a prediction unit configured to predict a future growth status based on the detected growth status, the current environment information and the past environment information, and mark and output an area and a part in the acquired image corresponding to an area and a part where damage to the object is likely to occur.

(2) In addition, the present invention provides the growth status prediction system described in (1). The system includes a coping approach display unit displaying a coping approach based on a result of the prediction.

(3) In addition, the present invention provides the growth status prediction system described in (1), where environment information acquired by the environment information acquisition unit refers to an accumulated temperature, an accumulated rainfall amount and an accumulated sunshine amount of the field.

(4) In addition, the present invention provides the growth status prediction system described in (1), where the prediction unit predicts according to a result learned by inputting the past environment information.

(5) In addition, the present invention is a growth status prediction method executed by a growth status prediction system configured to predict a growth status in a field, and the method includes: acquiring a captured image of the field; analyzing the image to detect a growth status of an object; acquiring current environment information of the field; acquiring past environment information of an object in the field; and predicting a future growth status based on the detected growth status, the current environment information and the past environment information, and marking and outputting an area and a part in the acquired image corresponding to an area and a part where damage to the object is likely to occur.

(6) In addition, the present invention is a computer-readable program configured to enable a computer configured to predict a growth status in a field to execute: acquiring a captured image of the field; analyzing the image to detect a growth status of an object; acquiring current environment information of the field; acquiring past environment information which is past environment information of the object in the field; and predicting a future growth status based on the detected growth status, the current environment information and the past environment information, and marking and outputting an area and a part in the acquired image corresponding to an area and a part where damage to the object is likely to occur.

### Effect of the Invention

According to the present invention, in addition to information such as the rainfall amount and the sunshine amount, image analysis of the field is combined for detecting the growth status and the disease and pest occurrence status and these statuses are applied to the prediction. Therefore, a more accurate prediction system, prediction method and program may be provided.

In addition, the present invention includes a coping approach display unit that displays a coping approach based on the prediction result, and thus, it is possible to provide a prediction system that is able to obtain not only the prediction result but also a most appropriate coping approach for solving the problem to be anticipated.

In addition, according to the present invention, the accumulated temperature, the accumulated rainfall amount, and the accumulated sunshine amount are used as environment information and used for prediction. Therefore, it is possible to provide a suitable prediction system with higher accuracy by focusing on important items that determine the growth of the object.

In addition, according to the present invention, the prediction unit makes a prediction according to the result learned by inputting the past environment information, and thus, it is possible to provide a suitable prediction system with higher accuracy that can effectively use past data.

### BRIEF DESCRIPTION OF DRAWINGS

FIG. 1 is a diagram showing an outline of a growth status prediction system.

FIG. 2 is a diagram showing a composition of the growth status prediction system.

FIG. 3 is a block diagram showing a function composition of the growth status prediction system.

FIG. 4 is a flowchart showing a growth status prediction processing executed by the growth status prediction system.

FIG. 5 is a diagram showing an example of an acquired image and growth data obtained by analyzing the image.

FIG. 6 is a diagram showing an example of current environment information and past environment information.

FIG. 7 is a diagram showing an example of a prediction result and a coping approach.

### DETAILED DESCRIPTION

Hereinafter, specific embodiments of the present invention will be described in detail, but the present invention is not limited by the following embodiments, and can be appropriately modified and implemented within the scope of the present invention.

[Outline of Growth Status Prediction System 1]

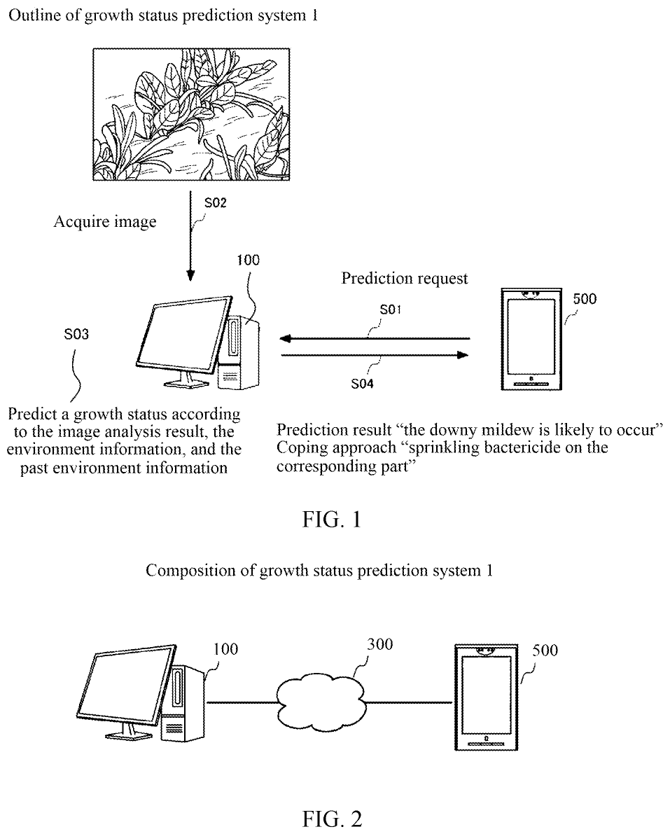

FIG. 1 is a diagram for describing an outline of a growth status prediction system 1 according to a preferred embodiment of the present invention. The growth status prediction system 1 includes a growth status prediction apparatus 100 and a user terminal 500.

In the growth status prediction system 1, first, the user terminal 500 transmits a growth status prediction request to the growth status prediction apparatus 100 (step S01). The growth status prediction request is composed of a combination of information about predicted area and information about predicted date and time period.

The growth status prediction apparatus 100 that has received the growth status prediction request acquires, according to information about an area in the growth status prediction request, image data of the area (step S02). Here, this may be done by the growth status prediction apparatus 100 itself having a shooting function for shooting, or by receiving image data from another apparatus having a shooting function, such as an unmanned aerial vehicle with a camera, via a network. In addition, the image is not limited to the captured image, and may also be generated and processed data.

The growth status prediction apparatus 100 that has acquired the image data analyzes the image data, and detects a current growth status as an image analysis result.

The growth status prediction apparatus 100 that analyzes the image data and detects the growth status acquires environment information about the current environment and past environment information about the past environment.

Then, based on the image analysis result, the environment information and the past environment information, a growth status of a date or a time period included in the prediction request is predicted (step S03).

The growth status prediction apparatus 100 acquires a coping approach for coping with a prediction result, and transmits the coping approach to the user terminal 500 together with the prediction result (step S04).

The user terminal 500 receiving the prediction result and the coping approach displays the prediction result and the coping approach through a display unit.

The above is the outline of the growth status prediction system 1.

(System Composition of Growth Status Prediction System 1)

FIG. 2 is a diagram of the system composition of the growth status prediction apparatus 100 according to a preferred embodiment of the present invention. As shown in FIG. 2, the growth status prediction system 1 includes a growth status prediction apparatus 100 and a user terminal 500. The growth status prediction apparatus 100 may communicate with the user terminal 500 via a public line network 300 (Internet, the third generation communication network, the fourth generation communication network, etc.).

The growth status prediction apparatus 100 has a function described later, is able to perform data communication, and is an electric appliance for home or work. The growth status prediction apparatus 100 may be, for example, a portable telephone, a portable information terminal, a smartphone, a tablet terminal, a netbook terminal, a tablet terminal, an e-book terminal, a portable music player, and other informative home appliances in addition to a personal computer or a server apparatus.

The user terminal 500 also has a function described later, is able to perform data communication, and is an electric appliance for home or work.

(Description of Each Function)

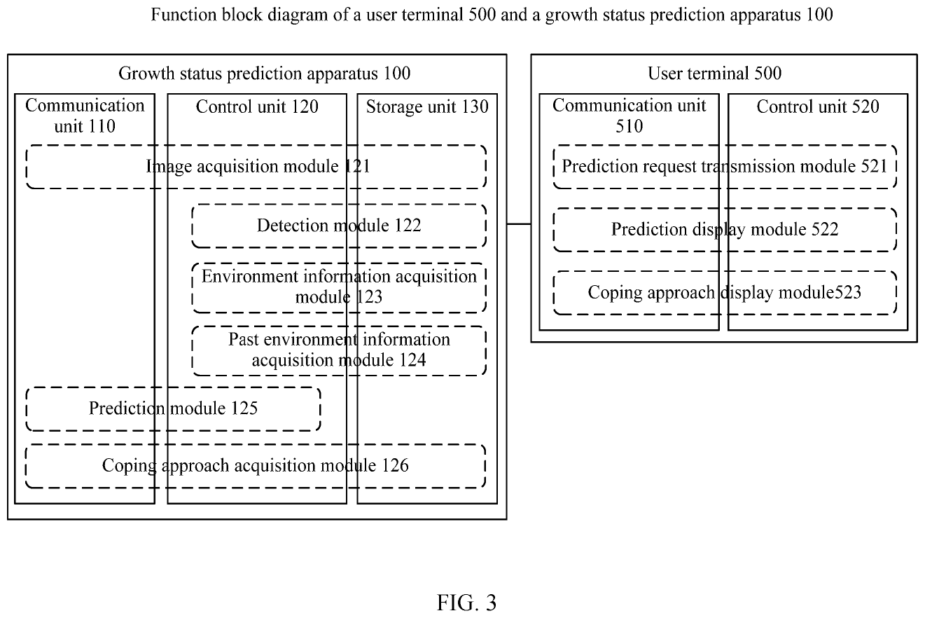

Based on FIG. 3, the composition of each apparatus will be described.

The growth status prediction apparatus 100 includes a central processing unit (CPU), a random access memory (RAM), a read only memory (ROM) and the like as a control unit 120, and a device which can communicate with other devices as a communication unit 110, such as a wireless-fidelity (Wi-Fi) enabled device that is compliant with IEEE802.11

Furthermore, the growth status prediction apparatus 100 includes a data storage unit, such as a hard disk, a semiconductor memory, a recording medium or a memory card, as a storage unit 130 for storing data and files.

In the growth status prediction apparatus 100, the control unit 120 reads a predetermined program and cooperates with the storage unit 130 to implement a detection module 122, an environment information acquisition module 123, and a past environment information acquisition module 124. In addition, in the growth status prediction apparatus 100, the control unit 120 reads the predetermined program and cooperates with a communication unit 110 to implement a prediction module 125. Furthermore, in the growth status prediction apparatus 100, the control unit 120 reads the predetermined program and cooperates with the communication unit 110 and the storage unit 130 to implement an image acquisition module 121 and a coping approach acquisition module 126.

The user terminal 500, similar to the growth status prediction apparatus 100, includes a CPU, RAM, ROM and the like as a control unit 520, and includes a device which can communicate with other appliances and wireless access points as a communication unit 510, such as a WiFi enabled device compliant with IEEE802.11 or a wired device.

In the user terminal 500, the control unit 520 reads a predetermined program and cooperates with the communication unit 510 to implement a prediction request transmission module 521, a prediction display module 522, and a coping approach display module 523.

(Growth Status Prediction Processing)

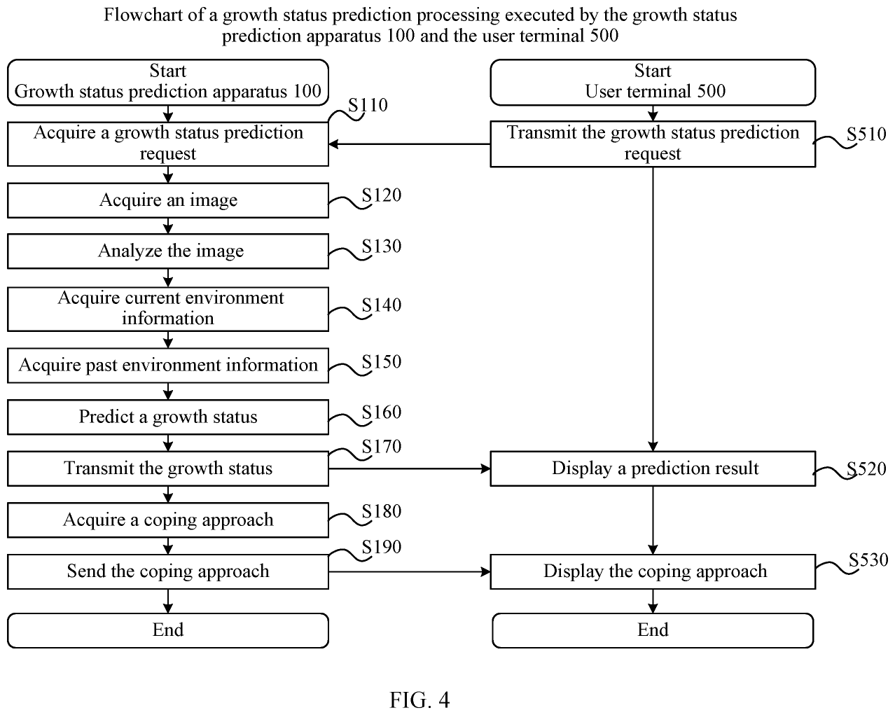

FIG. 4 is a flowchart showing a growth status prediction processing executed by a growth status prediction apparatus 100 and a user terminal 500. Processings executed by the modules of the above apparatuses will be described together with this processing.

First, the prediction request transmission module 521 of the user terminal 500 transmits a growth status prediction request to the growth status prediction apparatus 100 (step S510). The growth status prediction request, as described above, is composed of a combination of information about a predicted area and information about a predicted date and time period.

Next, when acquiring the growth status prediction request (step S110), the image acquisition module 121 of the growth status prediction apparatus 100 acquires image data of the area according to information about the area included in the growth status prediction request (step S120). It should be noted that the growth status prediction request does not necessarily only need to be sent from the user terminal 500, and may be generated in the growth status prediction apparatus 100.

Here, as an image acquisition method, the image may be acquired by the growth status prediction apparatus 100 itself having a shooting function for shooting, or by receiving image data from another apparatus having a shooting function, such as an unmanned aerial vehicle with a camera, via a communication 110. In addition, the image is not limited to the captured image, but may also be generated and processed data.

Next, the detection module 122 of the growth status prediction apparatus 100 analyzes the acquired image data, thereby detecting the growth status and acquiring growth data of the object (step S130).

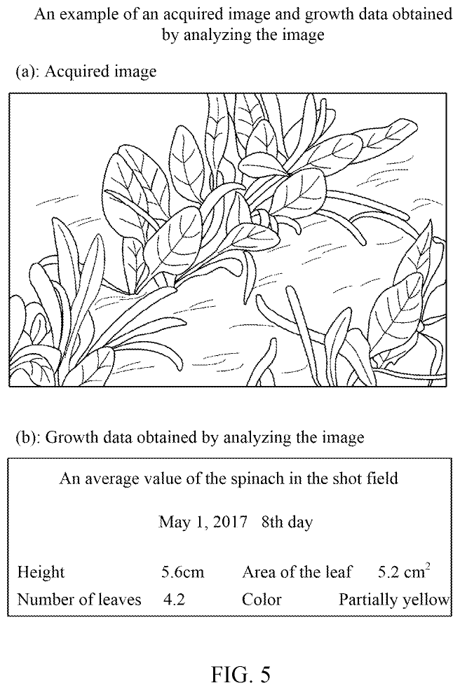

FIG. 5 is a diagram showing an example of image data and growth data acquired by analyzing the image data in a case where Spinach is taken as an object to predict the growth status. In the example of the image data shown in FIG. 5 (a), the object is shown in an enlarged manner for simplification, but actually, a captured image of the entire field is acquired as the image data.

As shown in FIG. 5 (b), the growth data may be acquired by analyzing the captured image of the entire field. In this example, a height of the object from the ground, an area of the leaf, the number of leaves, and a color of the leaf are acquired as an average value of the spinach in the shot field. Furthermore, for example, it is detected that the color of the leaves is partially changed to yellow in a part of the field.

Next, the environment information acquisition module 123 of the growth status prediction apparatus 100 acquires current environment information in the field (step S140). The acquired environment information is, for example, accumulated temperature, accumulated rainfall amount and accumulated sunshine amount of the field from the starting of planting to the present. In addition, as the environment information, prediction information about diseases and pests issued by Ministry of Agriculture, Forestry and Fisheries, and prediction information and warning information about diseases and pests issued by each prefecture control station are used, including prediction on pests flying in the field over the past years. In this case, a latitude and longitude of the field may be used as information for determining the position.

Next, the past environment information acquisition module 124 of the growth status prediction apparatus 100 acquires the past environment information in the field (step S150). The past environment information of the field refers to information in planting in the past (e.g., last year and the year before last) with respect to information which is the same as the current environment information. It should be noted that the past environment information may be information pre-stored in the storage unit 130 of the growth status prediction apparatus 100, and may also be acquired from another database through the communication unit 110.

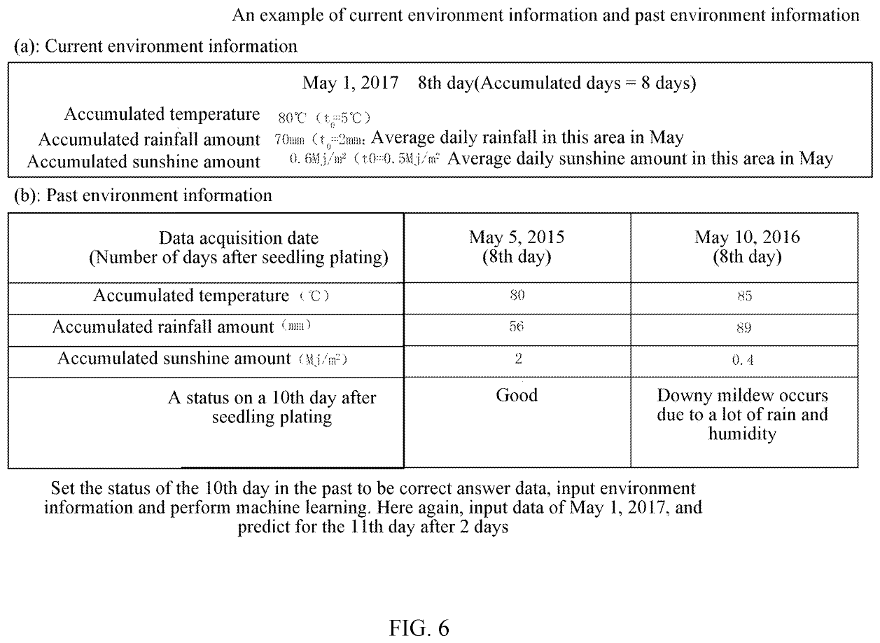

FIG. 6 is a diagram showing an example of current environmental information and past environmental information. In FIG. 6 (a), as the current environment information, the accumulated temperature, the accumulated rainfall amount and the accumulated sunshine amount of an object (spinach in this example) that is being currently grown are shown from a cultivated date to the present (the 8th day in this example). In FIG. 6 (b), as the past environment information, the environment information on the day with the same cumulative number of days as the present day (the 8th day in this example) last year and the year before last is shown.

In addition, in the growth status prediction system in this embodiment, machine learning is performed by inputting environmental information using the past 10th day's state as correct answer data. Therefore, in the example shown in FIG. 6 (b), states on the 10th day after planting last year and the year before last are acquired as past environment information.

That is, as environment information on the 8th day after planting last year, data such as an accumulated temperature of 85° C., an accumulated rainfall amount of 89 mm, and an accumulated sunshine amount of 0.4 Mj/m² are obtained, and as the correct answer data representing the state on the 10th day, data “downy mildew occurs due to a lot of rain and humidity” is obtained.

In addition, as environment information on the 8th day after planting the year before last, data such as an accumulated temperature of 80° C., an accumulated rainfall amount of 56 mm, and an accumulated sunshine amount of 2 Mj/m² are obtained, and as the correct answer data representing the state on the 10th day, data “good” is obtained.

Then, after acquiring the past environment information, the prediction module 125 of the growth status prediction apparatus 100 predicts the growth status based on the growth status detected in step S130, the current environment information acquired in step S140, and the past environment information acquired in step S150 (step S160).

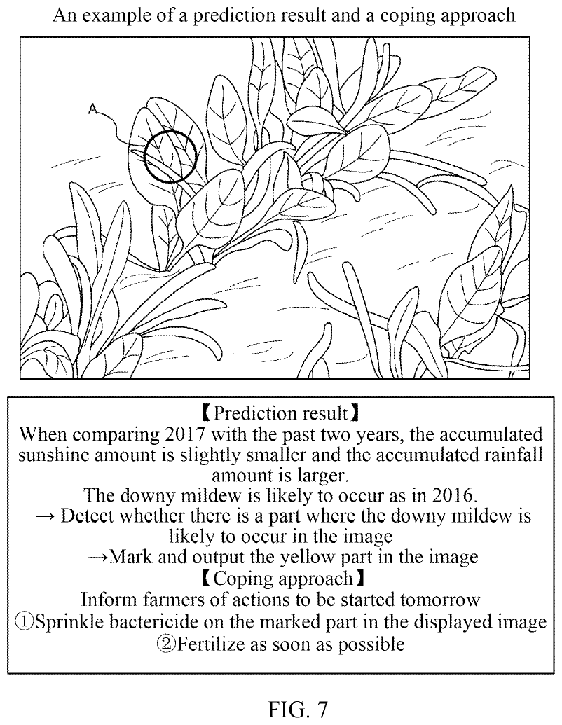

As shown in FIG. 6, in this embodiment, when compared with the past two years, the accumulated sunshine amount is slightly smaller and the accumulated rainfall amount is larger. Therefore, as shown in FIG. 7, as a prediction result, a result that the downy mildew is likely to occur as in 2016 may be obtained.

In addition, based on the image analysis result, it is possible to identify the part where the downy mildew is likely to occur. In other words, a part in the acquired image where the downy mildew is likely to occur is detected, marked and output. In this embodiment, the part where the downy mildew is likely to occur is detected, and similarly, a part where other diseases are likely to occur and a part where damage by pests is likely to be large are also detected. In this way, not only the occurrence of diseases and pests can be predicted, but also the area and part of the occurrence can be determined, so that a growth status prediction system with a high precision is able to be implemented.

When the prediction result is obtained, the growth status prediction apparatus 100 transmits the prediction result to the user terminal 500 (step S170), and the user terminal 500 receiving the prediction result displays the received prediction result on a displayer or the like provided on the user terminal 500 (step S520).

After sending the prediction result to the user terminal 500, the coping approach acquisition module 126 of the growth status prediction apparatus 100 acquires the coping approach based on the prediction result acquired in step S160 (step S180).

As shown in FIG. 7, in this embodiment, as a prediction result, predictions “the accumulated sunshine amount is slightly small and the accumulated rainfall amount is relatively large” and “the downy mildew is likely to occur as in 2016” are made. In addition, the part where the downy mildew is likely to occur is determined and marked with A. In step S180, based on such prediction result, a coping approach such as “sprinkling bactericide on the marked part” and “fertilizing as soon as possible” is acquired.

When the coping approach is obtained, the growth status prediction apparatus 100 transmits the coping approach to the user terminal 500 (step S190), and the user terminal 500 receiving the coping approach displays the received coping approach on a displayer or the like provided on the user terminal 500 (step S530).

It should be noted that in this embodiment, the coping approach is controlled to be acquired together with the prediction result, but it is not necessary to provide a function of acquiring the coping approach, and it may be a system only having the function of predicting the growth status. Alternatively, the growth status prediction request in step S510 may include selection information of the user about whether to obtain a coping approach. In this case, only when the user desires to acquire a coping approach, the coping approach is sent to the user.

The above is a processing order of the growth status prediction processing executed by the growth status prediction apparatus 100 and the user terminal 500.

The above units and functions are implemented by reading and executing specified programs by a computer (including a CPU, an information processing apparatus and various terminals). The programs are provided in the form of being recorded on a computer-readable recording medium such as a floppy disk, a compact disk (CD) (such as a compact disc read-only memory (CD-ROM)), and a digital versatile disc (DVD) (such as a digital versatile disc read-only memory (DVD-ROM) and a digital versatile disc random access memory (DVD-RAM)). In this case, the computer reads the programs from the recording medium and transfers the programs to an internal storage device or an external storage device for storage and execution. Furthermore, the programs may also be recorded in advance on a storage apparatus (recording medium) such as a magnetic disk, an optical disk or a magneto-optical disk, and provided to the computer from the storage apparatus via a communication line.

The embodiments of the present invention have been described above, but the present invention is not limited to the above embodiments. In addition, the effects described in the embodiments of the present invention are merely illustrative of the best effects produced by the present invention, and the effects of the present invention are not limited to the contents described in the embodiments of the present invention.

As an object for predicting the growth status, an example of spinach on the farm has been described, but the present invention is not limited to this embodiment, and can also be applied to forestry and aquaculture, especially in porphyra cultivation in addition to the agriculture.

The growth status prediction apparatus 100 and the user terminal 500 are configured as different devices, but the growth status prediction apparatus 100 and the user terminal 500 may also be configured as an integrated apparatus.

Disease and pest determination, growth investigation, fertilization timing, type of fertilizer, pesticide distribution timing, and type of pesticide may also be used as a prediction result and a coping approach.

### REFERENCE LIST

1 Growth status prediction system
100 Growth status prediction apparatus
500 User terminal
121 Image acquisition module
122 Detection module
123 Environment information acquisition module
124 Past environment information acquisition module
125 Prediction module
126 Coping approach acquisition module.

1-6. (canceled)

7. A growth status prediction system, configured to predict a growth status in a field, and comprising:
an image acquisition unit configured to acquire a captured image of the field;
a detection unit configured to analyze the image to detect a growth status of an object;
an environment information acquisition unit configured to acquire current environment information of the field;
a past environment information acquisition unit configured to acquire past environment information which is past environment information of the object in the field; and
a prediction unit configured to predict a future growth status based on the detected growth status, the current environment information and the past environment information, mark and output an area and a part in the acquired image corresponding to an area and a part where damage to the object is likely to occur.

8. The growth status prediction system of claim 7, further comprising:
a coping approach display unit configured to display a coping approach based on a result of the prediction.

9. The growth status prediction system of claim 7, wherein the environment information acquired by the environment information acquisition unit comprises an accumulated temperature, an accumulated rainfall amount and an accumulated sunshine amount of the field.

10. The growth status prediction system of claim 7, wherein the prediction unit is configured to predict according to a result learned by inputting the past environment information.

11. A growth status prediction method executed by a growth status prediction system configured to predict a growth status in a field, comprising:
acquiring a captured image of the field;
analyzing the image to detect a growth status of an object;
acquiring current environment information of the field;
acquiring past environment information which is past environment information of the object in the field; and
predicting a future growth status based on the detected growth status, the current environment information and the past environment information, and marking and outputting an area and a part in the acquired image corresponding to an area and a part where damage to the object is likely to occur.

12. A computer-readable program configured to enable a computer configured to predict a growth status in a field to execute:
acquiring a captured image of the field;
analyzing the image to detect a growth status of an object;
acquiring current environment information of the field;
acquiring past environment information which is past environment information of the object in the field; and
predicting a future growth status based on the detected growth status, the current environment information and the past environment information, and marking and outputting an area and a part in the acquired image corresponding to an area and a part where damage to the object is likely to occur.
